(19) United States
(12) Patent Application Publication
(10) Pub. No.: US 2003/0183094 A1
(43) Pub. Date: Oct. 2, 2003

(54) Method and system for disposal of refuse

(76) Inventors: William E. Wagner, Satellite Beach, FL (US); Mark Wagner, Satellite Beach, FL (US)

Correspondence Address: Robert L. Wolter, Esquire, Beusse, Brownlee, Bowdoin & Wolter, P.A., Suite 2500, 390 North Orange Avenue, Orlando, FL, 32801, US

(21) Appl. No.: 10/109,069

(22) Filed: Mar. 27, 2002

(51) Int. Cl. B30B 1/00

(52) U.S. Cl. 100/227

(57) ABSTRACT

A system and method for the disposal of refuse from refuse bins in a public dining area of a restaurant to a dumpster located outside the restaurant. The system includes a refuse container, the use of which is restricted to transferring refuse-filled bags from refuse bins to a staging area located toward a rear of the restaurant. The volume of the refuse-filled bag is reduced by a compaction device and placed on a shuttle, which is used to transfer the refuse-filled ages to the dumpster.

### FIELD OF THE INVENTION

This invention relates to methods or systems for disposal of refuse from public dining facilities.

### BACKGROUND OF THE INVENTION

The cost for management and disposal of refuse in the operation of a public dining facility, especially a fast food restaurant, is often overlooked or under appreciated. A restaurant operator typically contracts with a private waste management company for refuse pickup. Currently, refuse disposal in public dining facilities, especially fast food restaurants is performed without any guidelines or discipline, injecting a myriad of problems within the restaurant that increases the cost of operating the public dining facility.

Typically, refuse bins are disposed at locations within, or around the dining area. An employee removes refuse-filled plastic bags from a bin and carries it directly to a dumpster, or to an area removed from the public dining area. The refuse includes, food products, liquids, or other fluid matter, that leaks onto dining area floor. Usually, the plastic bags are maintained in an area in the restaurant where they leak further on the floor. An employee then must clean the soiled areas, which prevents the employee from performing tasks that produce cash flow for the restaurant. In addition, refuse leakage may create a hazard, in which employees and/or patrons may injure themselves, which may lead to potential claims against the restaurant owner.

Oftentimes, an employee may place the refuse within a portable hopper for transportation to the dumpster. These hoppers are typically constructed of a plastic opaque material. The hoppers provide opportunity for employee theft, because employees are able to hide food and other items within the portable hopper. In addition, employees hide food, or other valuables, within empty shipping/storage boxes. The employee can then steal such items when the boxes are taken to the dumpster. The foregoing problems increase the cost of operating a restaurant by increasing opportunity for theft, injury to employees and patrons and decreasing the amount of time employees are spending on productive tasks.

### SUMMARY OF THE INVENTION

The present invention is for a system and method for disposal of refuse from a public dining facility (also referred to as a “restaurant”). The term refuse as used herein include any type of waste that may placed in refuse bins, or produced during the operation of a restaurant, including paper or plastic products, food, shipping storage boxes, etc.

The public dining facility typically has a plurality of refuse bins disposed about a dining area. Plastic refuse bags are placed within each of the refuse bins for collection of refuse deposited therein. The system includes at least one refuse container, the use of which is restricted to transporting the trash bags from the refuse bins to a designated refuse staging area. The refuse bags are transported from the public dining area to a refuse deflation device, in which the refuse bag is placed. This refuse deflation device reduces the volume occupied by the refuse within a confined area. The deflated refuse is placed upon a shuttle, which transports deflated refuse from the designated holding area to the dumpster outside. The refuse is collected until the shuttle is full for transportation to the outside dumpster. In addition to the foregoing, any empty boxes are broken down immediately after removal of the contents within the box, and placed at the staging area, or on the shuttle at the staging area, for removal to the dumpster.

In this manner, the refuse is deflated to reduce the volume to a level that does not reach a point or level of compaction, which will increase the charge for refuse pickup. In addition, employees' trips to the dumpster are reduced, and the use of a designated refuse container eliminates spills within the public dining area and staging areas, thereby reducing time spent by employees on cleaning and reducing potential liability for injury resulting from these spills. In addition, opportunities for employee theft are reduced.

### BRIEF DESCRIPTION OF THE DRAWINGS

FIG. 1 is a schematic illustrating the system and method for the present invention.

FIG. 2 is a side elevational view of a shuttle used in the present invention.

FIG. 3 is an end elavational view of a shuttle use in the present invention.

### DETAILED DESCRIPTION OF THE INVENTION

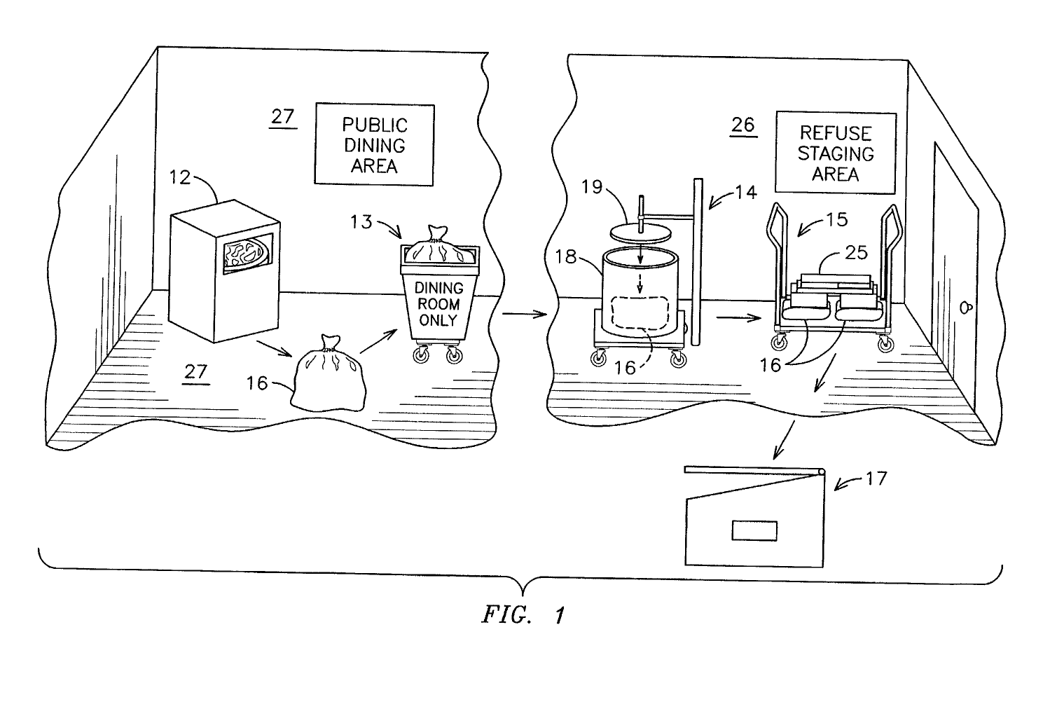

The system for the disposal of refuse from a public dining facility, having a dining area 27, is illustrated in FIG. 1. The bin 12 represents a refuse bin, and/or plurality of refuse bins, adjacent a public dining area 27 within a restaurant. These refuse bins 12 are located at or near the dining area 27 and condiment station (not shown), or counter (not shown) at which orders are taken. The system includes the refuse container 13, refuse deflator 14 and shuttle 15 for removing refuse from the dining area 27 and transporting it to a dumpster 17 located outside a restaurant.

During the course of a work day, patrons or employees of the restaurant will dispose of refuse within the refuse bins 12 located throughout the restaurant. The refuse bins 12 contain plastic trash bags 16. When the trash bags 16 are filled with refuse, employees of the restaurant must remove the refuse bags 16 from the bin 12 for disposal within the dumpster 17.

In the present invention, a refuse container 13, the use of which is restricted to transporting the refuse bags 16 from the refuse bins 12 to a designated staging area within the restaurant between the public dining area and a dumpster 17 located outside the restaurant. The refuse container 13 may be particularly designated with a written label citing its restricted use. Alternatively, the refuse container 13 may be labeled by a color designating its restricted use. The refuse container 13 is preferably mounted on a rolling dolly or casters for easy transportation of the refuse.

The refuse bags 16 are removed from the refuse bin 12 and replaced into the refuse container 13, which is then moved to the refuse staging area 26 in the rear of the restaurant. The refuse bags 16 are then deflated, reducing the volume of occupied by the refuse. The trash deflation device 14 is positioned adjacent the staging area 26. This may include any device that is capable of sufficiently deflate the refuse in order to reduce the volume necessary to fulfill the objectives of the present invention. Such a device is disclosed in U.S. Pat. No. 5,619,915, and may be purchased from Pack-a-Drum, Inc. located in Satellite Beach, Fla.

In addition to the foregoing, refuse may also include boxes used for shipping and/or storage. If the contents are removed, and the box is no longer useful, the employee immediately reduces the box 25 to flattened position as shown in FIG. 1. The boxes 25 are placed within the staging area 26, or on the shuttle 15 at the staging area for removal to the dumpster 17.

The deflator 14 includes a container 18 having a plate member 19 disposed thereover. The compaction plate 19 is manually operable to descend within the container 19 and contact the refuse, deflating it to a desired volume. The refuse bag 16 is then removed and placed onto the shuttle 15 for staging until the shuttle 15 is taken to the dumpster 17 outside, where the refuse bags 16 are deposited for pickup.

The shuttle 15 preferably takes the form of a cart having an elevated platform 20 mounted on casters 24 for rolling it along a floor surface. The shuttle 15 has an open viewing area through which to inspect the refuse and refuse bags 16 or boxes 25. This prevents employee theft, which may be contributed to a closed containment area that can not be effectively inspected without removing the refuse bags 16.

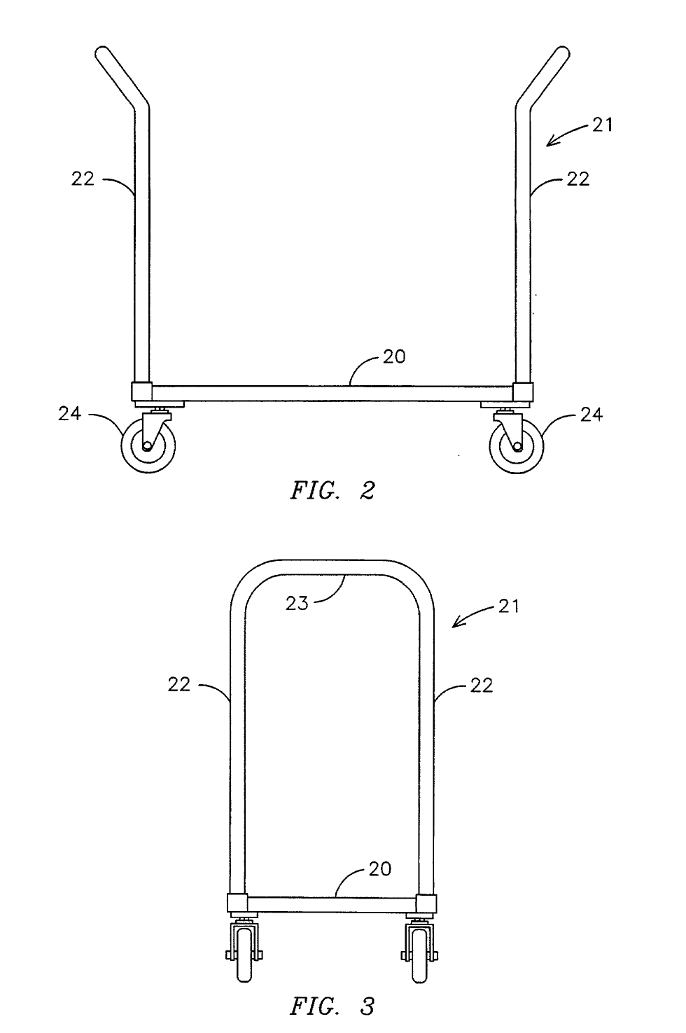

Retaining members 21 are mounted at each end of the platform 20. The retaining members 21 in the embodiment shown in FIG. 2 and FIG. 3, include upwardly extending, and parallel, bars mounted 22 to the platform. A cross member 23 extends intermediate the retaining bars 22, forming a handle to push and/or pull the shuttle for transportation of the refuse bags 16 and boxes 25. When the refuse bags 16, and/or boxes 25 are placed onto the platform 20, the retaining bars 21 maintain the trash on the platform 20. Once the shuttle 15 is filled with refuse bags 16, and/or boxes 25, the shuttle 15 is then transported to the dumpster 17 outside, in which the refuse bags 16, and/or boxes are deposited.

Waste management companies hired to remove the trash from the dumpster typically charge a monthly rate that is based on the volume of the dumpster, and the number of trash pickups per week. Specifically, the charge rate may be described in the following algorithm:

Rate/yd³ (dumpster volume in yd³) (number of pickups per week) 4.3_{AVG}

The number 4.3 represents a constant average representative of the number of weeks in any given month. The foregoing formula may be used to calculate a cost a restaurant owner may incur for removal of the trash from a dumpster. The rate per cubic yard may range from about $2 to about $12 per cubic yard, depending on the particular geographic market and other factors. Waste management companies are required to provide rate structures with the appropriate local and state agencies. The variable elements of the foregoing algorithm include dumpster size and number of pickups, which may be under the control of the restaurant owner. The restaurant owner can reduce the number of pickups by reducing the volume of the trash to a predetermined estimated volume. Alternatively the restaurant owner may reduce the dumpster size which reduces the volume of trash to the estimated volume, thereby, reducing the number of pickups per week.

Typically, the rate structures include a loose trash rate and a compacted trash rate. That is, waste management companies will charge a rate for a specified weight per cubic yard of trash up to a specific upper weight limit. Beyond that limit, refuse may be defined as “compacted” and charge a penalty rate which is typically a multiple of the base rate for “loose” trash. The compacted upper weight limit typically falls within the range of about 150-200 pounds/cubic yard. In order to minimize the cost for disposal of trash, a restaurant owner must reduce the volume of refuse without exceeding the upper weight limit—defined as “compacted” trash. If the refuse reaches the weight defined at the compacted rate, the restaurant owner will be fined a surcharge, increasing the cost for the pickups. The restaurant owner may be able empirically to estimate the number of bags containing “reduced” refuse before reaching the upper weight

While the invention has been described in what is presently considered to be a preferred embodiment, many variations and modifications will become apparent to those skilled in the art. Accordingly, it is intended that the invention not be limited to the specific illustrative embodiment but be interpreted within the full spirit and scope of the appended claims.

We claim as our invention:

1. A system for the disposal of low density refuse from a public dining facility to a refuse dumpster, and said dining facility having a dining area and refuse bins positioned thereabout, and said refuse bins having refuse bags within which refuse is deposited, the system comprising:
(a) at least one refuse container, the use of which is restricted to transporting trash bags filled with refuse from the refuse bins to a designated refuse staging area between the dining area and the dumpster;
(b) a refuse volume reduction device, positioned adjacent the refuse staging area, in which the refuse is placed and said device reduces a volume occupied by the refuse;
(c) a shuttle, upon which refuse is staged, for transporting deflated refuse from the designated staging area to the dumpster.

2. The system of claim 1 wherein said refuse container bears a label identifying its restricted use of transporting refuse from refuse bins to the designated staging area.

3. The system of claim 1 wherein said refuse container has a color representative of its restriction of the use of the refuse container for transporting refuse from bins to the designated staging area.

4. The system of claim 1 wherein said refuse container includes a plurality of casters mounted to a bottom of the container.

5. The system of claim 1 wherein said shuttle comprises:
(a) a platform upon which the refuse is placed;
(b) a plurality of casters mounted to the platform; and,
(c) at least one upwardly extending retaining member mounted to the platform for retaining refuse on the platform.

6. The system of claim 1 where said shuttle comprises a viewing area from which to inspect the refuse and refuse trash bags.

7. The system of claim 5 wherein said retainer member includes two vertically disposed, substantial parallel bars, and a cross member extending intermediate the members.

8. The system of claim 1 wherein said refuse deflation device comprises:
(a) a container within which the refuse bags may be placed, said container having a sidewall extending upwardly from a bottom and a top opening, and said refuse occupying a volume there within;
(b) a plate disposed over the opening; and,
(c) an actuator, connected to the plate, to adjust the plate in and out of the container to reduce the volume of the refuse occupied within the container.

9. A method for the disposing of refuse from a public dining area to a refuse dumpster, and said dining area having refuse bins positioned therein, and said refuse bins having refuse bags within which refuse is deposited, the system comprising, the steps of:
(a) providing a refuse container having a use restricted to transferring refuse from the refuse bins to a refuse staging area;
(b) transferring refuse deposited within the refuse bins to the refuse staging area, using said refuse container;
(c) reducing the volume of the refuse occupied by the refuse within a confined area; and
(d) transporting the refuse bags, after reducing the volume of the refuse, to the dumpster.

10. The method of claim 9 wherein said refuse comprises boxes, and further including the steps of breaking down the boxes to a substantially flattened position and transferring the boxes to the refuse staging area.

11. The method of claim 9 further comprising the step of accumulating the refuse bags at the staging area for a time duration after which the refuse bags are transported to the dumpster.

12. The method of claim 9 wherein the step of providing the refuse container comprises labeling the container with a designation representative of its restricted use.

13. The method of claim 8 further comprising the step of providing a cart for maintaining the refuse bags on said staging area and transferring the refuse bags from the staging area to the dumpster.

14. A method for disposing of refuse from a public dining area to an outside dumpster from which the refuse is removed at a removal rate based on the dumpster volume of refuse and the number of times the refuse is removed from the dumpster in a given time duration;
(a) identifying an upper weight limit of refuse within a dumpster above which the removal rate will be increased;
(b) reducing the number of refuse pickups per time duration by increasing the weight of refuse placed within the dumpster without exceeding the upper weight limit.

15. The method of claim 14 further comprising the steps of reducing the volume of the refuse occupied by the refuse within a container, and transferring the refuse to the dumpster.

16. The method of claim 14 further comprising the step of providing a container for transferring refuse from the refuse bins to a staging area between the public dining area and the dumpster, and restricting the use of the container to transferring the refuse from the refuse bins to the staging area.

17. The method of claim 15 further comprising the step of reducing the volume occupied by the refuse within a confined area before transferring the refuse to the dumpster.

18. The method of claim 16 further comprising the steps of providing a shuttle, having an open viewing area with which to inspect the refuse, maintaining the refuse on the shuttle in the staging area, and transporting the refuse to the dumpster on the shuttle.

19. A method for the disposal of refuse, occupying volume from a public dining facility:
(a) transferring refuse within the public dining facility to a refuse staging area removed from a dining area in the facility;
(b) reducing the refuse at or adjacent the staging area; and
(c) transporting the refuse to a dumpster outside the facility.

20. The method of claim 19 wherein the step of reducing the volume of the refuse includes breaking down boxes and placing the boxes within the staging area.

21. The method of claim 19 wherein the step of reducing the volume of refuse comprises placing refuse-filled bags within a refuse deflation device and operating said device to reduce the volume of refuse.
